(19) United States
(12) Patent Application Publication
(10) Pub. No.: US 2004/0016564 A1
(43) Pub. Date: Jan. 29, 2004

(54) Expanded insulating sleeve with edge support

(75) Inventor: Robert L. Lambert JR., Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/205,151

(22) Filed: Jul. 25, 2002

(51) Int. Cl. H02G 15/08

(52) U.S. Cl. 174/93; 138/110

(57) ABSTRACT

A protective assembly for covering cable connections and splices and the like. The protective assembly comprises a rigid support structure including a resin composition. The rigid support structure has the shape of a hollow elongate tube in a central portion thereof and further includes a first reinforced end portion opposite a second reinforced end portion. A rigid support structure supports an elastic tube capable of recovering substantially to its original dimensions after being stretched and released. The elastic tube in the protective assembly is held in an expanded condition extending beyond the end of a rigid support structure placed inside the elastic tube. The rigid support structure is susceptible to breaking upon the application of a force beyond that exerted by the tube while in its expanded condition. Application of the force breaks the rigid support structure to permit recovery of the elastic tube.

### FIELD OF THE INVENTION

The invention relates to protective, elastic, insulating sleeves held in expanded condition using frangible support cores and more particularly to expanded sleeves supported on crushable cores that include edge reinforcement preventing inadvertent core fracture when at least one end of an insulating sleeve overlaps the end of a support core.

### BACKGROUND OF THE INVENTION

Tubular articles are known for electrically insulating and protectively sealing sections, particularly spliced sections and connections of, for example, electrical wires and cables, and optical fibers and related elongate structures. Shrinkable insulating tubular articles were developed to provide a relatively rapid and convenient way to install insulation around points of connection between electrical wires and cables. Heat shrinkable tubes represent one form of shrinkable insulation that requires heat to cause tube shrinkage. Tube shrinkage occurs during softening of tube material that was previously frozen in a stretched condition. The amount of heat required to heat-shrink an insulating tube may also be sufficient to overheat and damage an underlying wire connection or splice. This problem led to the development of elastic tubes held in a stretched condition using internal or external support cores. Upon removal of the support core an elastic tube recovers to its original dimensions under ambient conditions. Insulating tubes shrinking under ambient conditions include those described as cold-shrink tubes. U.S. Pat. No. 3,515,798 describes cold-shrink tubing including an internal support holding an elastomeric tube in an expanded condition. The support is a tube produced by winding a continuous narrow strip of tough flexible material into a helix that has intermittent points of connection to hold adjacent coils together. Application of an elastomeric tube around a wire connection or splice occurs by positioning a splice inside the support and pulling an end of the strip, forming the helix, to fracture the points of connection. Breakage of coil connecting links causes the helix to collapse and the elastomeric tube to contract as it surrounds the spliced section of wire.

U.S. Pat. No. 4,070,746, U.S. Pat. No. 4,585,607 and U.S. Pat. No. 4,656,070 use external supports holding internally mounted elastomeric tubes in an expanded condition. Separation of an elastomeric tube from its external support requires weakening of the bond between the support and the expanded tube using either a chemical agent or force that destroys the supporting structure.

Application of tubular insulation using expanded elastic tubes, having either internal or external supports, also produces residual strips or fragments of material used for the support structures. Residual strips and fragments require collection and suitable disposal. Problems of disposal for support structures were overcome using crushable supports designed to disintegrate into fragments substantially contained by a tubular insulator after contracting from its expanded condition. Crushable support structures include those described in U.S. Pat. No. 2,725,621, U.S. Pat. No. 5,406,871, and U.S. Pat. No. 5,746,253 and European Patent EP 0 530 952. Containment means for support residues may include fluid adhesives and sealants in the vicinity of a shrunken tubular insulator. The description of U.S. Pat. No. 2,725,621 indicates the need for sharp impact and associated excessive force to shatter a metal or plastic sleeve to allow contraction of the expanded protector it supports.

Crushable support structures generally fall into the category of internal supports or cores because material fragments remain inside the insulating tube following destruction of the support. Although offering advantages over heat-shrink tubes and cold-shrink tubes, insulating tubes using crushable cores have a problem that also affects all known cold-shrink tubes using internal support means. Recovery forces present in the expanded tube may cause collapse of the support core ends if an expanded tube is longer than its support core. This problem was avoided previously using support structures that were longer, or at least equal in length, to the longitudinal axis of the tubular insulator. For improved retention of crushed core fragments there is a need to provide insulating tubular articles supported by crushable cores that are shorter in length than the tubular articles themselves.

### SUMMARY OF THE INVENTION

Crushable support structures according to the present invention permit the use of lengths of stretched elastic tubing extending beyond one or both ends of the support structure or core. Core structures of uniform wall thickness may be divided into desired lengths before inserting them as supports to retain elastic tubes in an expanded condition. Such core structures typically exhibit resistance to compressive forces associated with stretched elastic tubing that could cause the core to collapse. The compressive forces of an expanded elastic tube are relatively evenly distributed provided the elastic tube is shorter in length than its support core. If the expanded tube overlaps either or both ends of the core there is contact of the tube against the end of the support core. The ends of a crushable support of substantially uniform wall thickness have less resistance to the compressive forces produced by a stretched elastic tube. This leads to instability of a support core, which may collapse by crack development and propagation from its ends.

The problem of core collapse propagating from the ends may be overcome, according to the present invention using a support structure having a central portion, of substantially uniform wall thickness, between thicker or wider reinforced portions at each end. The central portion may be a continuous wall of substantially uniform thickness. Optionally, the central portion may comprise a perforated wall of substantially uniform thickness, containing circular, or triangular or rectangular openings or openings of any one or a combination of available shapes. The reinforced end portions of a crushable core according to the present invention have the shape of a ring or shallow, hollow cylinder that fractures in controllable fashion without the use of an impact tool. Introduction of reinforced sections into support cores represents an improvement based particularly on the use of crushable cores. Variation of support capability within a selected core provides an improved, versatile support structure.

Before the introduction of shrinkable articles supported on crushable cores there was no need to consider containment of material generated during contraction of shrinkable insulation. The use of heat-shrink products was free from residual material. Also, it was common practice to separately dispose of waste support core material after applying a cold-shrink product to e.g. cables and spliced sections of cables.

Core waste retention was made possible using crushable cores. Typically, core fragments remain substantially confined between a substrate and a contracted elastic tube or sleeve after a support core has been crushed. Manufacture of existing crushable cores requires a balance between the core's ability to withstand contraction forces of an expanded tube, which it supports, and the compressive force needed to break the core upon demand, without impact or excessive force. Open-structure crushable cores, as described in U.S. Pat. No. 5,406,871, and U.S. Pat. No. 5,746,253, reduce the amount of material to be retained after crushing the core. Such cores preferably have a lattice structure that is somewhat weaker than solid crushable cores. The strength of a uniform elongate lattice structure decreases towards its opposing terminal portions. Using cores with a substantially uniform wall thickness, it is necessary for the core to be longer than the expanded elastic tube it supports. This avoids the potential problem in which the central portion of the core may be strong enough to support an expanded tube but the end portions may crack and collapse under the force produced by the expanded tube as it attempts to contract to its original dimensions. Once begun, in any part of the support core, the process of collapse continues to destruction of the lattice structure. It will be appreciated that end portions of crushable support cores extending beyond an expanded elastic tube remain outside the ends of the tube and avoid capture and retention inside a contracted tube after the core has been crushed into fragments.

The present invention provides improvement in fragment retention using crushable cores having reinforced ends of sufficient strength to support an expanded tube having wraparound ends extending over ends of the support core. While providing suitable support, the reinforced ends break under reasonable force without the use of sudden impact. A non-uniform core, supporting an expanded insulating tube, remains confined within a tube that extends over the ends of the core. Core fragments, produced by crushing the core, are less likely to be lost from inside a tube that extends beyond the ends of a support core, particularly if the core-supported elastic tube includes a layer of sealant or adhesive.

More particularly the present invention provides a protective assembly for covering wire and cable connections and splices. The protective assembly comprises a rigid support structure including a resin filled with micro-beads having an average particle size from about 20 μm to about 100 μm. The rigid support structure has the shape of a hollow elongate tube that may include a lattice of longitudinal and transverse members defining a plurality of uniformly spaced openings in a central portion thereof. Further, the rigid support structure includes a first reinforced end portion opposite a second reinforced end portion.

A rigid support structure according to the present invention supports an elastic tube capable of recovering substantially to its original dimensions after being stretched and released. The elastic tube in the protective assembly is held in an expanded condition to extend over at least the first reinforced end of a rigid support structure placed inside the elastic tube. The rigid support structure is susceptible to breaking upon the application of a force beyond that exerted by the tube while in its expanded condition. Application of the force breaks the rigid support structure to permit recovery of the elastic tube.

### DEFINITIONS

Terms used herein have the meanings indicated by the following definitions:

The term “cold shrink product” refers to structures including elastic elements supported on a collapsible core comprising a rigid material. Collapsible cores include hollow tubular structures formed from brittle materials or plastic, helically wound ribbon structures.

As used herein a “crushable core” is a brittle hollow tubular structure comprising a rigid material including thermoplastic or thermoset resin compositions, and glasses and ceramic and inorganic materials such as cement or plaster of paris that may be formed or cast to provide a crushable core. Crushable cores according to the present invention may have continuous or perforated walls.

The term “non-uniform core” refers to a support core having variable wall thickness or strength characteristics.

The term “uniform core” or “uniform dimensions” or the like refers to properties of support cores that are substantially unchanged throughout the core structure. Uniformity may refer to wall thickness or the distribution and size of openings in a perforated core.

The term “overhanging” refers to an elastic tube held in expanded condition using a crushable support core that is shorter in length than the elastic tube, leaving unsupported ends of the elastic tube hanging over or extending beyond the ends of the support core.

As used herein, terms such as “support,” “core,” and “support core” and the like may be used interchangeably to refer to structures used to hold elastic elements such as elastic tubes in expanded condition during storage.

The term “lattice” refers to an open framework including regular patterned spaces.

The beneficial effects described above apply generally to the exemplary devices and mechanisms disclosed herein of the protective assembly. The specific structures though which these benefits are delivered will be described in detail hereinbelow.

### BRIEF DESCRIPTION OF THE DRAWINGS

The invention will now be described in greater detail with reference to the attached drawings in which:

FIG. 1 is a perspective view of a crushable core according to the present invention.

FIG. 2 is a perspective view of an alternate crushable core according to the present invention.

FIG. 3 is a perspective view of an additional embodiment of a crushable core according to the present invention.

FIG. 4 is a side view showing an elastic tube supported in expanded condition by a crushable core shown in the partial cut-away portion of the figure.

FIG. 5 shows a perspective view of an open ended, elastic tube held in expanded condition using a crushable core according to the present invention.

FIG. 6 is a perspective view showing an elastic tube, closed at one end, held in expanded condition by a crushable core according to the present invention.

FIG. 7 is a perspective view of a closed-end, elastic tube held in expanded condition over a crushable core that includes a layer of fluid sealant.

FIG. 8 shows a pigtail splice covered by an insulated, elastic, closed-end tube shrunk around the splice by crushing a support core according to the present invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

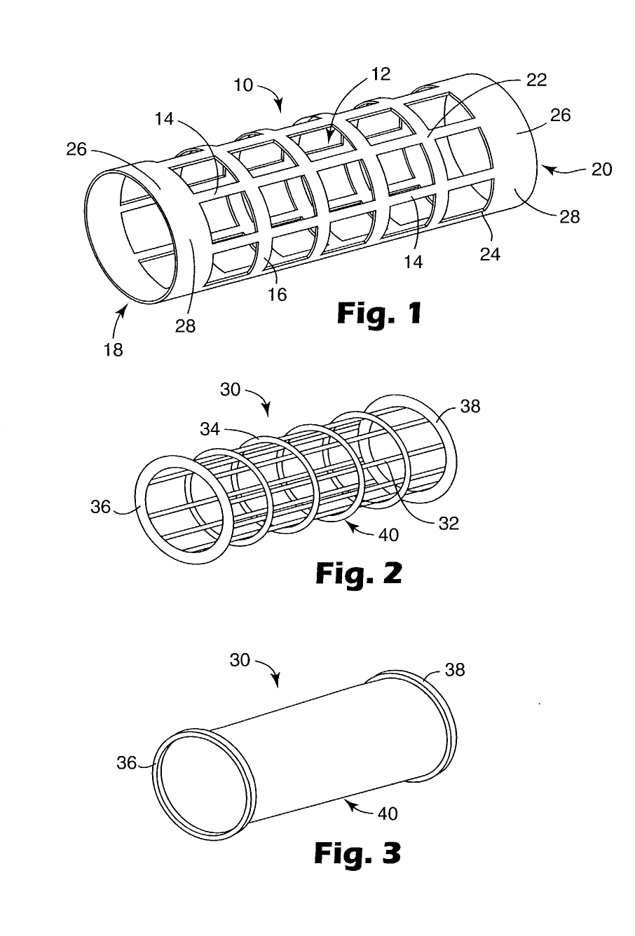

Referring now to the figures wherein like numerals represent like parts throughout the several views, FIGS. 1-3 show several alternative embodiments of non-uniform crushable core structures. FIG. 1 is a preferred embodiment of a crushable core 10 that includes a central tubular lattice 12 having frangible zones formed by intersection of longitudinal ribs 14 and transverse ribs 16. Opposing, first 18 and second 20 end portions of the crushable core 10 resemble the transverse ribs 16 but are dimensionally enlarged to provide reinforced portions 18, 20 at each end of the tubular lattice 12. Intersection of longitudinal ribs 14 and transverse ribs 16 produces crossover points 22 including four support members consisting of two longitudinal ribs 14 and two transverse ribs 16. Crossover points 22 differ from junction points 24 formed where longitudinal ribs 14 intersect with the first end portion 18 and the second end portion 20 of the crushable core 10. Junction points 24 include three support members, one provided by a longitudinal rib 14 and two provided by a first spar 26 and a second spar 28 included as sections of each end portion 18, 20. If the dimensions of the first and second spars 26, 28 are the same as those of transverse ribs 14, a junction point 24, having only three members, would be weaker than a crossover point 22 that includes four members. This discussion suggests that end portions of previously described uniform lattice core structures should be weaker than the central portion of such crushable cores. Variability of the strength of a support core along its length provides a reason why elastic tubes, held in expanded condition, could collapse inadvertently by propagation of cracks initiated within the weaker end portions of a crushable core. To overcome premature core collapse, it has become commonplace to load expanded elastic tubes on crushable cores without extending over the ends of the crushable support core.

Without extension of an expanded elastic tube beyond the crushable core, fragments from the crushed core fall outside the area covered by the protective tube. Lost core fragments produce undesirable debris during installation of insulating tubes around wire connections or splices. This problem drives the need for improved crushable support cores that may be non-uniform dimensionally while possessing substantially consistent strength and support properties from end to end. Consistent core strength may be achieved according to the present invention as previously described for FIG. 1 and also using the alternative embodiments of FIG. 2 and FIG. 3.

The lattice core 30 of FIG. 2 differs from FIG. 1 in using longitudinal filaments 32 to replace longitudinal ribs 14 for connecting transverse rings 34 that correspond to the transverse ribs 16 illustrated in FIG. 1. As shown, longitudinal filaments 32 and transverse rings 34 have a circular cross section rather than the rectangular cross section of longitudinal ribs 14 and transverse ribs 16. Crushable core structures of the type shown in FIG. 2 include a first end ring 36 and a second end ring 38 each having a diameter that is greater than any of the rings 34 in the central portion 40 of the lattice core 30. Increasing the cross sectional diameter of the end rings 36, 38 makes them stronger to provide uniform strength and support characteristics along the length of the crushable support core 30.

FIG. 3 shows a crushable support core 30 including a continuous wall as the central portion 40 of the core 30. The common feature of each of the support cores shown in FIGS. 1-3 is the positioning of reinforced sections at the ends of each core to provide consistent support characteristics to prevent inadvertent collapse of the ends of the core.

The purpose of each type of crushable core previously described is to provide a support that maintains overhanging elastic tubes in an expanded condition. Use of the term “overhanging” implies that the ends of supported, expanded elastic tubes extend outwardly to wrap around the ends of the reinforced support. Placement of an elastic tube in expanded condition over a crushable support core provides an article that may be used to apply elastomeric electrical insulation around a bare, potentially live, electrically conducting structure such as a wire connection or splice.

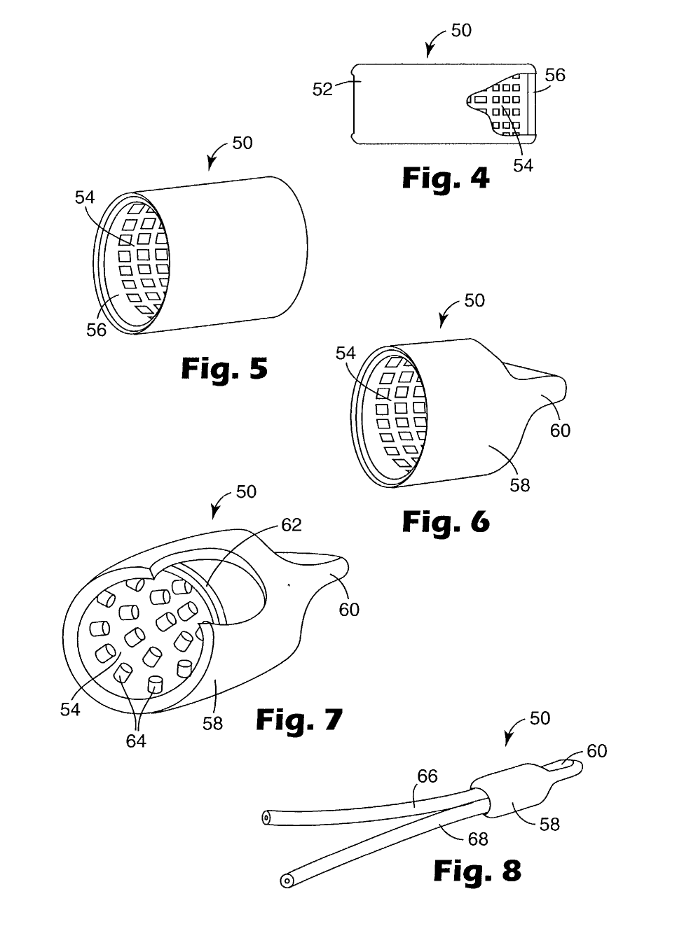

FIG. 4 is a side elevation showing an insulating assembly 50 using a flexible elastomeric sleeve as an elastic tube 52 held in expanded condition around a crushable support core 54. A portion of the crushable core 54 appears in the part of the elastic tube 52 that has been cut away to expose the underlying core. Under normal circumstances, the core cannot be seen because an end portion 56 of the elastic tube 52 overlaps the end of the crushable core 54. As described previously, the end portion of the support core 54 has been reinforced to avoid the possibility of premature core 54 and tube 52 collapse associated with support core failure that was relatively common with earlier types of crushable cores of uniform structure. FIG. 5 is a perspective view corresponding to FIG. 4 showing an insulating assembly 50 suitable for insulating and protecting one or more connections formed between electrical wires or optical fibers.

FIG. 6 shows an alternative embodiment of an insulating assembly 50 that includes an elastic sleeve 58 that has a closed end 60 and is open at the opposite end. The open end is held in expanded condition by a crushable core 54 to receive, for example, a pigtail connection produced by welding, soldering or otherwise connecting two or more wires at a common junction. After inserting the bare wire junction into the space inside the support core 54 the elastic tube may be shrunk around the junction by exerting sufficient gripping force on the insulating assembly 50 to overcome the resistance of the support core 54, which breaks into fragments. Core fragments remain substantially inside the elastic sleeve 58, which previously extended beyond the end of the support core 54. The effectiveness of core fragment retention improves if force to shrink the core assembly is applied first at the ends of the crushable support core, rather than in the more natural location, at the center of the tube.

FIG. 7 shows a modification of the insulating assembly 50 of FIG. 6 that includes a layer of fluid sealant 62 around the crushable core 54 before positioning an expanded elastic sleeve 58 over the support core 54. As shown in the previous figures, preferred support cores according to the present invention have a square mesh pattern with approximately 50% open areas on the core surface. This open structure facilitates collapse of an insulating assembly 50, during application of gripping pressure.

An elastic sleeve 58 placed around a crushable core 54 coated with fluid sealant exerts pressure against the sealant causing it to migrate through lattice openings to position small mounds 64 of fluid sealant 62 on the inside of the crushable support core 54. An insulating assembly 50 of this type not only offers the protection for wire and cable splices and connections, provided by an insulating elastic sleeve 58, but also provides the additional feature of hermetic sealing based upon the ability of the fluid sealant 62 to penetrate spaces inside the assembly 50 after crushing the core 54 and shrinking the elastic sleeve 58 around a wire or cable junction.

FIG. 8 shows the result of shrinking an expanded insulating sleeve 58, having a closed end 60, around a pigtail splice formed by connecting a first wire 66 to a second wire 68. The tube 58 shrinks and recovers close to its original dimension when the core fractures by application of external pressure. Collapse of the support structure or core 54 requires application of pressure, preferably not excessive pressure, beyond that exerted by the expanded tube itself. Protection of a splice or connection occurs with retention of core 54 fragments inside the shrunken elastic sleeve 58 of the insulating assembly 50.

Accommodation of crushed core fragments is an important feature of the present invention to avoid the need to dispose of surplus materials after installation of a shrinkable sleeve. It is required that core fragments, from a collapsed core, be small enough for easy retention within the elastic or conformable tube, after shrinking. Fragments that are too large could produce gaps adjacent to e.g. a wire connection. Such gaps allow fluids to penetrate inside the protective tube after application. Preferably, crushable cores according to the present invention have discontinuous, perforated or lattice-like walls including open spaces for better accommodation of crushed core fragments, also referred to herein as shards.

There are at least three advantages to insulating assemblies 50 according to the present invention that include elastic tubes 52, 58 overhanging or extending beyond the ends of crushable support cores 54. They facilitate production of a variety of types of assembly 50 optionally having one or both ends open to receive cable splices or connections or other structures inserted therein. Use of overhanging elastic tubes 52, 58 provides a reliable assembly 50 to contain crushed core fragments. The containment factor is particularly important when the insulating assembly 50 includes a fluid sealant capable of exuding from within a contracted splice cover to produce a sticky unsightly mess close to the splice or connection protected by the crush-shrinkable insulation.

Expandable, elastic tubes according to the present invention comprise any flexible, elastic material, which may be stretched to several times its original dimensions and recover substantially to its original size and shape upon release of the stretching force. Rubbery elastomers, such as natural rubber, synthetic rubber, silicone polymers and similar materials may be used in the form of expandable tubes 52, 58 according to the present invention. Preferred elastic materials include silicone rubbers, and ethylene-propylene-diene monomer terpolymers (EPDM). These materials may be formulated for varying expansion and recovery characteristics.

A support structure 54 to hold an elastic tube in an expanded condition comprises a brittle resin composition that optionally contains one or more types of particulate fillers. Thin-walled ceramic forms may also be used as collapse-on-demand support structures. Suitable brittle resins may be selected from polymers generally classified as polystyrenes, polyesters and polyacrylates. Preferred resins include rapid-cure epoxy resins, amine-cured, two part epoxy resins, transparent styrene polyester resins and solvent soluble acrylate resins. Filled resin support structures provide frangible or crushable cores that retain their shape, but fracture and collapse during the application of reasonable amounts of pressure, usually no greater than an intensified handgrip.

Preferred support core compositions contain reinforcing fillers such as fibers, flakes, micro-bubbles, and micro-beads and the like. Fillers improve strength and deformation resistance. Adjustment of filler concentration leads to desirable ranges of pressure needed to cause crack propagation and core collapse.

Considering all types of materials, including thermoplastic resins, thermoset resins, glasses and ceramic materials, which are useful as core materials, the preferred continuous resin phase comprises a thermoplastic resin. Moreover, the continuous resin phase may contain micro-beads in a range of diameters from about 20 μm to about 100 μm, preferably from about 50 μm to about 60 μm. Micro-bead to binder ratios, by volume, below about 1:2 render the support core too flexible, while ratios above about 2:1 yield cores that are too brittle to provide support to an expanded tube.

Cover assemblies, also referred to as insulating assemblies 50, may optionally include a layer of adhesive or sealant material for improved retention of core fragments and more effective sealing of splices and connections. Suitable sealant materials include viscous fluids, for example a gel designated as DOW CORNING 6-6636, available from Dow Corning Corp., Midland, Mich., and a mastic product identified as PRESS-IN-PLACE BATH TUB SEALANT, available from 3M Company of Maplewood Minn. The latter product gave desirable results as a sealant and a shard-retention material.

A variety of forming methods, including casting and molding, may be used to produce crushable cores. Addition of reinforced ends to supports according to the present invention has relied upon casting thickened portions at each end of a previously formed core that may have a continuous wall or a perforated wall including circular or rectangular openings. Previously formed cores are typically tubes having a wall of substantially constant longitudinal thickness, whether perforated or not. Instead of casting thickened ends onto such tubes, crushable supports with end reinforcement may be produced using a single step injection molding process.

The use of casting provided a preferred crushable support including a tube having a perforated wall, about 1.0 mm (0.04 inch) thick, containing holes arranged in a square mesh or lattice. Lattice dimensions were selected to place rectangular holes at a pitch of about 6.2 mm (0.25 inch), the holes being separated by ribs about 1.5 mm (0.06 inch) wide. A ring mold, attached at each end of a perforated tube, was filled with material to provide cast ends or terminal ribs about 4.5 mm (0.18 inch) wide and from about 1.5 mm (0.06 inch) to about 1.75 mm (0.07 inch) thick. Rib thickness in excess of about 1.75 mm has proved difficult to break as required of cold shrink tubular elements using crushable supports.

Suitably formed crushable supports were positioned inside expanded elastic tubes to provide cold shrink insulating assemblies capable of shrinking, on demand, during application of pressure, usually by squeezing, to crush the core. Dimensions of crushable cores included an inner diameter of about 33.0 mm (1.3 inches), and an outer diameter about 35.6 mm (1.4 inches). Unexpanded tube dimensions for use with these supports depend upon the elastic material selected. An appropriately sized ethylene propylene diene monomer (EPDM) elastic tube has a diameter of about 17.3 mm (0.68 inch) and a wall thickness of about 4.6 mm (0.18 inch). Alternatively a silicone elastomer tube having a diameter of about 16.3 mm (0.64 inch) and a wall thickness of about 4.3 mm (0.17 inch) may be used.

The process of loading a tube onto a crushable support required stretching the tube into a condition wherein the inner radius of the tube exceeded the outer radius of a crushable support. Overhanging ends of the elastic tube were supported until the crushable support was correctly positioned inside the tube, and approximately at its center. A mandrel was inserted into the crushable support to fill the space inside the support and prevent premature collapse as the expanded tube was released from its supports to contract against the surface of the crushable support. Removal of the mandrel gave a cold shrink tubular element comprising an elastic tube overhanging the ends of a support that has sufficient strength to hold the elastic tube in an expanded condition prior to the application of a compressive force.

The known use of sealants with insulating tubular members is an option with cold shrink insulating assemblies according to the present invention. Sealants, as described previously, may be applied either inside or outside of the crushable supports before loading of the elastic tubes. The portions of an elastic tube overhanging the ends of the crushable support may also include a coating of sealant as an aid to retention of support fragments after collapse of the support. A preferred cold shrink tube according to the present invention optionally includes a layer of fluid sealant or mastic conveniently applied to the outside of a perforated, crushable support before loading an expanded elastic tube onto the support. The expanded tube exerts pressure against the fluid sealant, which flows through the perforations to form islands of sealant on the inside surface of the crushable support.

Protective assemblies, for connections and splices and components thereof, have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention, embodied in various forms, and described by the claims.

What is claimed is:

1. A protective assembly for connections and splices of the type produced by wires and cables, said protective assembly comprising:
a rigid support structure, having the shape of a hollow tube in a central portion thereof, said rigid support structure further including a first reinforced end portion opposite a second reinforced end portion; and
an elastic tube capable of recovering substantially to its original dimensions after being stretched and released, said elastic tube in said protective assembly being held in an expanded condition to extend beyond at least said first reinforced end of a said rigid support structure placed inside said elastic tube, said rigid support structure further being susceptible to breaking upon the application of a force beyond that produced by said tube in said expanded condition such that application of said force breaks said rigid support structure to permit recovery of said elastic tube.

2. The protective assembly of claim 1, wherein said rigid support structure includes a resin composition.

3. The protective assembly of claim 2, wherein said resin composition includes a resin selected from the group consisting of thermoplastic resins and thermoset resins.

4. The protective assembly of claim 2, wherein said resin composition includes a filler, selected from the group consisting of particles, fibers, flakes, micro-bubbles and microbeads and mixtures thereof.

5. The protective assembly of claim 4, wherein said micro-beads have a particle size from about 20 μm to about 100 μm.

6. The protective assembly of claim 5, wherein said micro-beads have a particle size from about 40 μm to about 60 μm.

7. The protective assembly of claim 1, wherein said central portion is a perforated portion including a plurality of spaced openings.

8. The protective assembly of claim 7, wherein said plurality of spaced openings has the form of a lattice of uniformly spaced shaped openings.

9. The protective assembly of claim 8, further including longitudinal and transverse members defining said lattice having uniformly spaced rectangular openings.

10. A protective assembly for covering connections and splices produced by joining filaments, said protective assembly comprising:
a rigid support structure including a resin filled with micro-beads having an average particle size from about 20 μm to about 100 μm, said rigid support structure having the shape of a hollow elongate tube including a lattice of longitudinal and transverse members defining a plurality of uniformly spaced openings in a central portion thereof, said rigid support structure further including a first reinforced end portion opposite a second reinforced end portion; and
an elastic tube capable of recovering substantially to its original dimensions after being stretched and released, said elastic tube in said protective assembly being held in an expanded condition by placement of a said rigid support structure inside said elastic tube, said rigid support structure further being susceptible to breaking upon the application of a force beyond that produced by said tube in said expanded condition so that application of said force breaks said rigid support structure to permit recovery of said elastic tube.
